(19) United States
(12) Patent Application Publication
(10) Pub. No.: US 2017/0351312 A1
(43) Pub. Date: Dec. 7, 2017

(54) SEMICONDUCTOR DEVICE

(71) Applicant: Renesas Electronics Corporation, Tokyo (JP)

(72) Inventors: Takashi Iwase, Tokyo (JP); Ken Matsubara, Tokyo (JP); Hidenori Mitani, Tokyo (JP); Hiroshi Sato, Tokyo (JP)

(21) Appl. No.: 15/482,187

(22) Filed: Apr. 7, 2017

(30) Foreign Application Priority Data
Jun. 7, 2016 (JP) 2016-113774

(51) Int. Cl. G06F 1/30; G06F 1/26; G06F 11/14

(52) U.S. Cl. CPC G06F 1/30; G06F 11/1441; G06F 1/263; G06F 2201/84

(57) ABSTRACT

There is to provide a semiconductor device capable of storing save data at a shutdown of a power. The semiconductor device of receiving the power includes a memory unit having a plurality of memory cells capable of storing data, a power detecting circuit that detects shutdown of the power, and a condenser capable of temporarily supplying an operation voltage, instead of the power, at the power shutdown. The memory unit includes a voltage generating unit that generates a plurality of writing voltages based on the operation voltage from the condenser at the power shutdown and a writing circuit that performs data writing of save data for a plurality of memory cells, based on the writing voltages generated by the voltage generating unit.

### CROSS-REFERENCE TO RELATED APPLICATIONS

The disclosure of Japanese Patent Application No. 2016-113774 filed on Jun. 7, 2016 including the specification, drawings and abstract is incorporated herein by reference in its entirety.

### BACKGROUND

This disclosure relates to a semiconductor device, and particularly to a semiconductor device of a micro-computer including a non-volatile memory.

When power is shut down at a side of a system, like a blackout, on the way of writing data, the data writing operation is interrupted. Generally, the data stored in a storing device as a file format is stored with a code for error detection and correction added to a lump of the data in order to detect and correct an error bit, and therefore, when the operation is interrupted on the way of writing data, the data becomes mixed with new data and old data and the error detection and correction code does not match with the new data nor the old data, which results in a high possibility of error.

In Japanese Unexamined Patent Application Publication No. 2006-163753, there is disclosed a method of completing data writing according to a remaining charge, after interrupting the transfer of signals with an external unit when detecting the shutdown of power.

When power is shut down at one side, it is regarded as an emergency state and preferably, control data (save data) to be saved should be stored.

In order to solve the above problem, this disclosure is to provide a semiconductor device capable of storing the save data at the power shutdown.

Other objects and novel features will be apparent from the description of this specification and the attached drawings.

### SUMMARY

According to one embodiment, a semiconductor device of receiving a power includes a memory unit having a plurality of memory cells capable of storing data, a power detecting circuit that detects shutdown of the power, and a condenser capable of temporarily supplying an operation voltage, instead of the power, at the power shutdown. The memory unit includes a voltage generating unit that generates a plurality of writing voltages based on the operation voltage from the condenser at the power shutdown and a writing circuit that performs data writing of the save data for a plurality of memory cells, based on the writing voltages generated by the voltage generating unit.

According to one embodiment, the save data can be stored at the power shutdown.

### BRIEF DESCRIPTION OF THE DRAWINGS

FIG. 1 is a block diagram showing a structure of a semiconductor device based on a first embodiment.

FIGS. 2A, 2B, and 2C are views for use in describing a structure and operation of a memory cell.

FIG. 3 is a block diagram showing a structure of a flash memory module 4 of FIG. 1.

FIG. 4 is a view for use in describing timing at the power shutdown based on the first embodiment.

FIG. 5 is a view for use in describing a flow of an evacuation mode by the flash memory module 4 based on the embodiment.

FIG. 6 is a block diagram showing a structure of a micro-computer 1A based on a second embodiment.

FIG. 7 is a view for use in describing timing at the power shutdown of an internal power based on a second embodiment.

FIG. 8 is a block diagram showing a structure of a micro-computer 1B based on a third embodiment.

FIG. 9 is a view for use in describing timing at the power shutdown of an external power based on the third embodiment.

FIG. 10 is a flow chart for use in describing recovering processing of a semiconductor device based on a fourth embodiment.

### DETAILED DESCRIPTION

One embodiment will be described in details with reference to the drawings. The same reference numerals are attached to the same components or the corresponding portions and their description is not repeated.

### First Embodiment

### <A. Structure of Micro-Computer>

### (a1. Whole Structure)

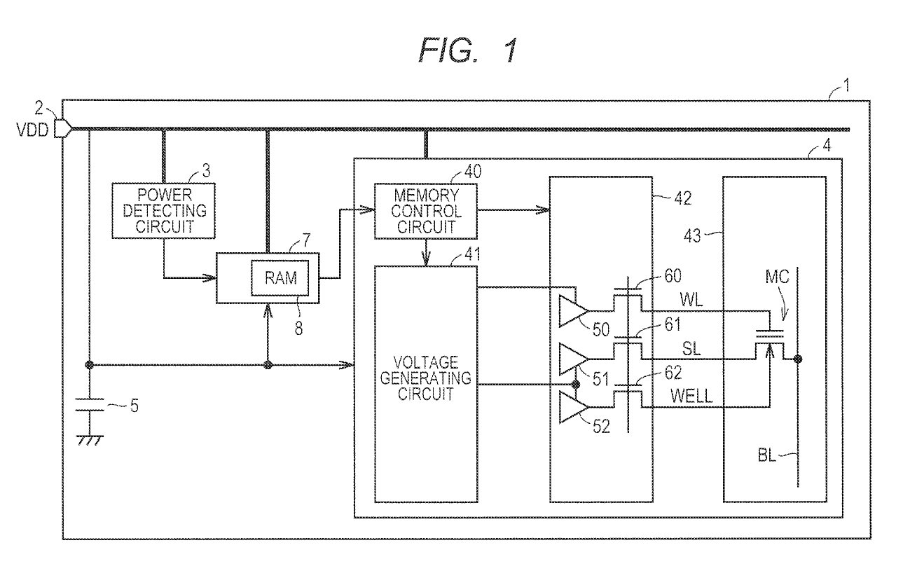

FIG. 1 is a block diagram showing a structure of a semiconductor device based on the first embodiment.

With reference to FIG. 1, the structure of a micro-computer (MCU) 1 as an example of a semiconductor device is shown here.

The micro-computer 1 is formed into one semiconductor chip such as single crystal silicon, by using, for example, Complementary Metal Oxide Semiconductor (CMOS) integrated circuit manufacturing technique.

The micro-computer 1 includes a controller 7 and a flash memory module 4. The controller 7 may be realized by a central processing unit (CPU). Further, in this example, the controller 7 includes a random access memory (RAM) 8. The controller 7 includes an instruction control unit and an executing unit, to perform an instruction. The flash memory module 4 is provided as a non-volatile memory for storing data and program.

The RAM 8 stores control data to be stored and used for a work region. The controller 7 obtains a control parameter of each unit within the micro-computer at a predetermined frequency and stores the above in the RAM 8 as the control data.

The micro-computer 1 includes a power pad 2 for receiving an external power VDD, a power bus 9 coupled to the power pad 2 for supplying the external power to each unit, and a power detecting circuit 3 for monitoring the state of the power supplied to the power bus 9.

Further, the micro-computer 1 includes a condenser 5 and a switch 6.

The condenser 5 has a capacity enough to temporarily supply an operation voltage at a power shutdown.

The switch 6 is provided to couple a path for supplying power to each unit based on the electric charge accumulated in the condenser 5.

The switch 6 is controlled according to an instruction from the controller 7.

The controller 7 instructs the flash memory module 4 to perform data writing, data reading, and initialization. According to the instruction from the controller 7, the flash memory module 4 controls the data writing, data reading, and initialization.

The flash memory module 4 includes a memory control circuit 40, a voltage generating circuit 41, a decoder group 42, and a memory mat 20.

The memory control circuit 40 controls the whole operation of the flash memory module 4.

The voltage generating circuit 41 generates various kinds of operation voltages necessary for the data writing, data reading, and initialization (erase).

Specifically, voltages respectively supplied to a word line WL, a source line SL, a well (WELL), and a bit line BL necessary for the data writing, data reading, and initialization (erase) are generated by the voltage generating circuit 41 according to the instruction from the memory control circuit 40 and supplied to the decoder group 42.

The decoder group 42 includes drivers 43 to 45 for driving the word line WL, the source line SL, and the well region, to drive the respective signal lines upon receipt of various kinds of necessary operation voltages from the voltage generating circuit 41.

Further, a select transistor 46 is provided between the driver 43 for driving the word line WL and the word line WL.

Further, a select transistor 47 is provided between the driver 44 for driving the source line SL and the source line SL.

Further, a select transistor 48 is provided between the driver 45 for driving a signal line WELL coupled to the well region and the same signal line WELL.

The select transistors 46 to 48 operate upon receipt of the control signal from the memory control circuit 40. Specifically, the memory control circuit 40 controls the conductivity and non-conductivity by outputting the control signal to the select transistors 46 to 48.

Although it is not illustrated, the voltage generating circuit 41 generates a voltage for driving a bit line and by way of example, supplies the voltage to a writing system circuit.

The memory mat 20 includes memory cells MC arranged in a matrix shape. The details of the memory mat 20 will be described later.

### (a2. Structure and Operation of Memory Cell)

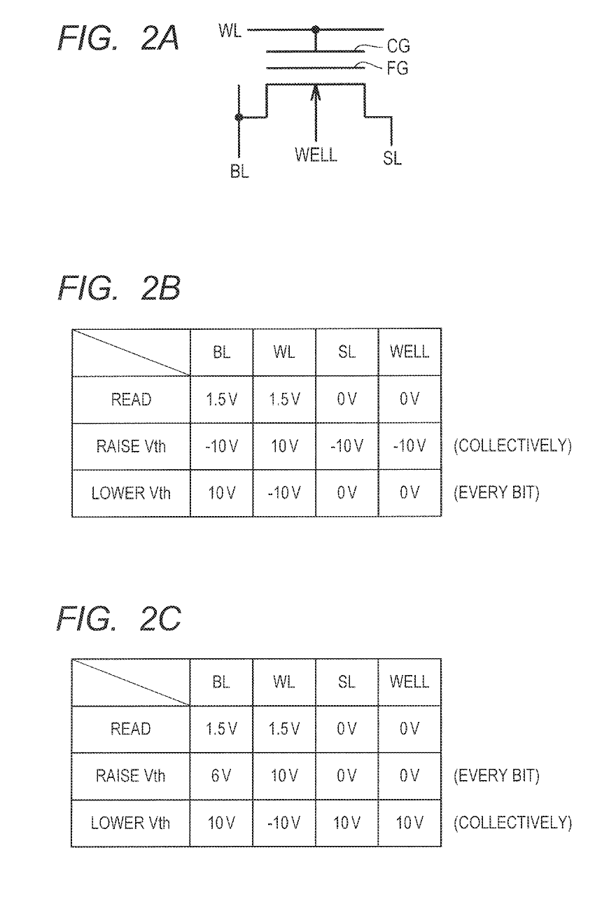

FIGS. 2A, 2B, and 2C are views for use in describing the structure and operation of a memory cell.

A stacked gate type flash memory element shown in FIG. 2A is formed by stacking a floating gate FG and a control gate CG on a channel forming region between the source region and the drain region through a gate insulating film. The control gate CG is coupled to the word line WL. The drain region is coupled to the bit line BL and the source region is coupled to the source line SL.

FIGS. 2B and 2C show an example of voltages set in the bit line BL, the word line WL, the source line SL, and the well region (WELL) at a time of reading, writing, and erasing of the stacked gate type flash memory element.

FIG. 2B shows an example of the voltages set in the case of raising a threshold voltage Vth according to an FN tunnel writing method and lowering the threshold voltage Vth by the release of electrons to the bit line BL

FIG. 2C shows an example of the voltages set in the case of raising the threshold voltage Vth according to a hot carrier writing method and lowering the threshold voltage Vth by the release of electrons in the well region.

Here, the control gate CG is also referred to as a control electrode, a dopant region coupled to the bit line BL is also referred to as a first main electrode, and a dopant region coupled to the source line SL is also referred to as a second main electrode.

At the reading time, the voltages are set as, for example, BL=1.5 V, WL=1.5 V, SL=0 V, and WELL=0 V. When the threshold voltage Vth of the memory cell is lower, the resistance of the memory cell is smaller (on state), while when the threshold voltage Vth is higher, the resistance of the memory cell is larger (off state).

To raise the threshold voltage Vth of the memory cell, the voltages are set as, for example, BL=−10 V, WL=10 V, SL=−10 V, and WELL=−10 V.

On the other hand, to lower the threshold voltage Vth of the memory cell, the voltages are set as, for example, BL=10V, WL=−10 V, SL=0 V, and WELL=0 V.

For example, when the threshold voltage Vth of the memory cell is high, the data of “1” or “0” can be stored; while when the threshold voltage Vth of the memory cell is low, the data of “0” or “1” can be stored.

### (a3. Structure of Flash Memory)

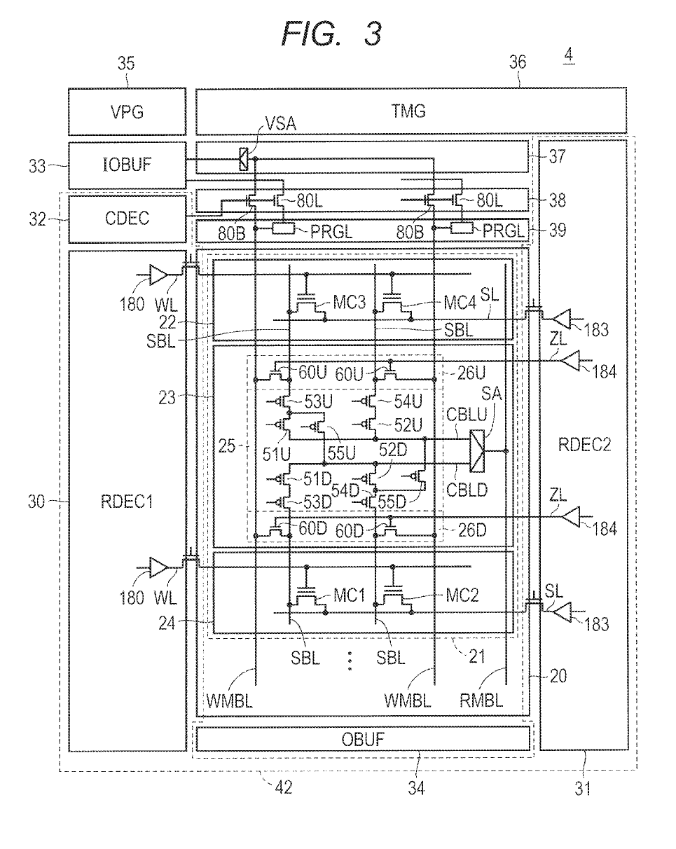

FIG. 3 is a block diagram showing the structure of the flash memory module 4 of FIG. 1.

With reference to FIG. 3, the vertical direction is referred to as a column direction, and the horizontal direction is referred to as a row direction. The flash memory module 4 includes the memory mat 20, an output buffer (OBUF) 34, and the decoder group 42.

In the example, the decoder group 42 includes a first row decoder (RDEC1) 30, a second row decoder (RDEC2) 31, and a column decoder (CDEC) 32.

The memory mat 20 includes a hierarchical sense amplifier band 23 and memory arrays 22 and 24 provided on the both sides of the hierarchical sense amplifier band 23 in the column direction, as one component unit (hereinafter, referred to as a memory block 21). The memory mat 20 includes a plurality of these memory blocks 21 in the column direction (FIG. 3 representatively shows only one memory block 21). Hereinafter, the memory array 22 is also referred to as “upper memory array 22” and the memory array 24 is also referred to as “lower memory array 24”.

The memory mat 20 includes a plurality of word lines WL extending in the row direction, a plurality of source lines SL extending in the row direction, and a plurality of sub bit lines SBL extending in the column direction. These control signal lines are provided in every memory array of 22 and 24.

The memory mat 20 includes a plurality of writing system main bit lines WMBL and reading system main bit lines RWBL provided in common in the memory mat 20. The respective writing system main bit lines WMBL, corresponding to the respective sub bit lines SBL, are coupled to the respective sub bit lines SBL through sub bit line selectors 26U and 26D. In other words, the writing system main bit lines WMBL and the sub bit lines SBL are formed in hierarchical structure.

Each of the memory arrays 22 and 24 includes a plurality of the memory cells MC in a matrix shape. Each row of the memory array corresponds to each of the plural word lines WL, and in other words, the word lines WL are provided by the unit of rows in every memory array. Each column of the memory arrays corresponds to each of the sub bit lines SBL. In other words, the sub bit lines SBL are provided by the unit of columns in the memory arrays. The source line SL is coupled to the memory array in common for the plural rows. At the data reading, the source line SL is coupled to the ground node VSS.

FIG. 3 shows the case of each memory cell being a stacked gate type flash memory element but it is needless to say that each memory cell may be a split gate type flash memory element.

In the flash memory module 4, a pair of rewritable non-volatile memory cells coupled to the common word line WL is used as a twin cell. In the memory array 24 of FIG. 3, a pair of the memory cells MC1 and MC2 coupled to the common word line WL is representatively shown. Similarly, in the memory array 22, a pair of the memory cells MC3 and MC4 coupled to the common word line WL is representatively shown. In the specification, the memory cells MC1 and MC3 are referred to as “positive cell” and the memory cells MC2 and MC4 are referred to as “negative cell”.

In the memory cells MC1 and MC2 forming the twin cell, their control gates CG are coupled to the corresponding common word line WL. The sources of the memory cells are coupled to the common source line SL. The memory cells MC1 and MC2 are respectively coupled to the corresponding sub bit lines SBL in every column unit.

The hierarchical sense amplifier band 23 includes a sense amplifier SA, a reading column selector 25, and the sub bit line selectors 26U and 26D.

The sense amplifier SA includes first and second input nodes, and amplifies a difference between a current flowing in a first output signal line CBLU coupled to the first input node and a current flowing in a second output signal line CBLD coupled to the second input node, to output the comparison result of the both current values. Hereinafter, the first output signal line CBLU is also referred to as an upper output signal line and the second output signal line CBLD is also referred to as a lower output signal line. The output signal of the sense amplifier SA is transmitted to the output buffer (OBUF) 34 through the reading system main bit line RMBL extending in the column direction. The output buffer 34 supplies the output from the sense amplifier SA to the CPU2 of FIG. 1.

The reading column selector 25 includes a plurality of PMOS transistors 51U to 54U and 51D to 54D, and by switching these PMOS transistors, it works as a connection switch for switching the connection of the sub bit lines SBL between the above output signal lines CBLU and CBLD (hereinafter, the MOS transistor used as the switch as mentioned above is also referred to as a MOS transistor switch). Basically, the sub bit line SBL used for the upper memory array 22 is coupled to the upper output signal line CBLU through the Positive-channel MOS (PMOS) transistor switches (51U, 53U; 52U, 54U). Similarly, the sub bit line SBL used for the lower memory array 24 is coupled to the lower output signal line CBLD through the PMOS transistor switches (51D, 53D; 52D, 54D).

Further, the reading column selector 25 includes the PMOS transistor switches 55U and 55D for coupling the negative cell to the output signal line (CBLU or CBLD) opposite to the coupling destination in the above basic case, in the case of the complementary reading method. For example, when reading the data of the twin cell formed by the memory cells MC1 and MC2, the memory cell MC1 is coupled to the lower output signal line CBLD through the PMOS transistor switches 53D and 51D. The memory cell MC2 is coupled to the upper output signal line CBLU through the PMOS transistor switches 54D and 55D. Similarly, when reading the data of the twin cell formed by the memory cells MC3 and MC4, the memory cell MC3 is coupled to the lower output signal line CBLD through the PMOS transistor switches 53U and 55U. The memory cell MC4 is coupled to the upper output signal line CBLU through the PMOS transistor switches 54U and 52U.

The sub bit line selectors 26U and 26D includes a plurality of Negative-channel MOS (NMOS) transistor switches 60U and 60D, and by switching on and off in the NMOS transistor switches 60U and 60D, it selectively couples the corresponding sub bit line SBL to the writing system main bit line WMBL.

Specifically, the sub bit line SBL provided in the memory array 22 is coupled to the corresponding main bit line WMBL through the NMOS transistor switch 60U. The sub bit line SBL provided in the memory array 24 is coupled to the corresponding main bit line WMBL through the NMOS transistor switch 60D. The sub bit line selectors 26U and 26D are used for the data writing only, not for the data reading.

The first row decoder (RDEC1) 30 includes a driver 180 for selectively activating the word line WL. The second row decoder (RDEC2) 31 includes a driver 183 for selectively activating the source line SL. The second row decoder 31 further includes a driver 184 for selectively activating the control signal line ZL for controlling the sub bit line selectors 26U and 26D.

The select transistor is provided between the driver 180 for driving the word line WL and the word line WL. Further, the select transistor is provided between the driver 183 for driving the source line SL and the source line SL.

The control signal line ZL is coupled to the gates of the NMOS transistor switches 60U and 60D provided in the sub bit line selectors 26U and 26D. The select operation by the first row decoder 30 and the second row decoder 31 follow the address information in the reading access, the writing operation, and the initialization operation (erasing operation).

The flash memory module 4 further includes the input output buffer (IOBUF) 33, a main bit line voltage control circuit 39, the column decoder (CDEC) 32, a rewriting column selector 38, a verify circuit 37, and a timing generator (TMG) 36.

The input output buffer (IOBUF) 33 is coupled to the controller 7. The input output buffer 33 receives the write data from the controller 7. The input output buffer 33 further outputs the judgment result of the verify sense amplifier VSA to the controller 7. Further, the input output buffer 33 outputs the reading data to the controller 7.

The main bit line voltage control circuit 39 includes a plurality of program latch circuits PRGL provided correspondingly to the respective writing system main bit lines WMBL. The program latch circuit PRGL holds the write data supplied through the input output buffer 33. In the data writing, a writing current according to the data (“1” or “0”) held in the corresponding program latch circuit PRGL selectively flows in the writing system main bit line WMBL.

The column decoder (CDEC) 32 generates a control signal for selecting the writing system main bit line WMBL, according to the address information.

A rewrite column selector 38 includes NMOS transistor switches 80B for selectively coupling the respective corresponding writing system main bit lines WMBL to the verify sense amplifier VSA and NMOS transistor switches 80L for selectively coupling the input output buffer 33 to the respectively corresponding program latch circuits PRGL. The NMOS transistor switches 80B and 80L are switched on or off according to the control signal from the column decoder 32. By turning on the NMOS transistor switch 80L, the write data is input from the input output buffer 33 to the corresponding program latch circuit PRGL.

By checking whether or not the data of the memory cell of a writing target agrees with the write data held in the program latch circuit PRGL, the verify circuit 37 determines whether desired data is written in the memory cell of the writing target. The verify circuit 37 includes a verify sense amplifier VSA for reading the data of the memory cell of the writing target. The verify sense amplifier VSA is coupled to the writing system main bit line WMBL corresponding to the memory cell of the writing target, according to the selecting operation of the rewrite column selector 38 (specifically, by turning on the corresponding NMOS transistor switch 80B).

The timing generator (TMG) 36 generates an internal control signal of defining an internal operation timing according to the instruction from the memory control circuit 40.

### <B. Operation Description at Power Shutdown>

### (b1. Timing Chart at Power Shutdown)

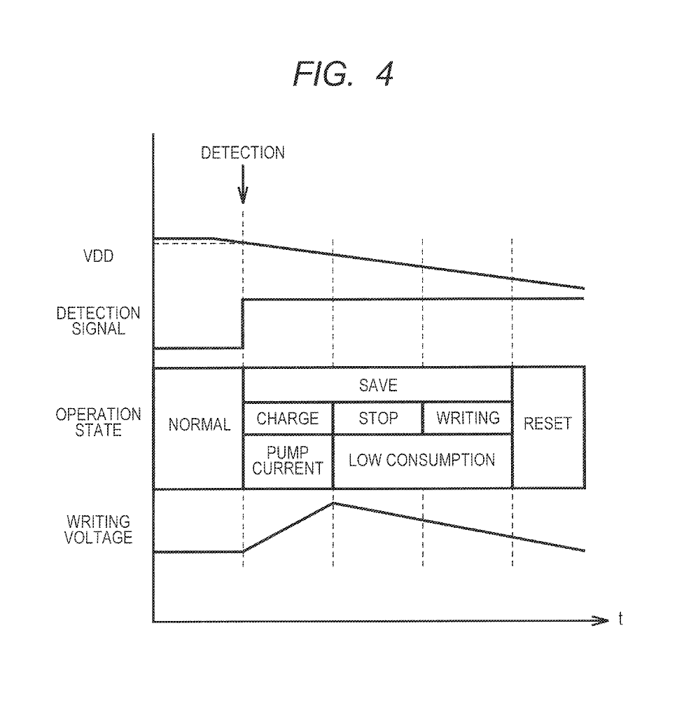

FIG. 4 is a view for use in describing timing at a power shutdown based on the first embodiment.

As shown in FIG. 4, at the time T1, when the external power VDD is lowered to a certain detection level, the power detecting circuit 3 outputs a detection signal (“H” level).

The power detecting circuit 3 outputs the detection signal to the controller 7.

Upon receipt of the detection signal (“H” level) from the power detecting circuit 3, the controller 7 instructs the flash memory module 4 to move from the normal (Normal) mode to the evacuation mode. Further, the controller 7 reads the save data stored in the RAM 8 and outputs the save data to the flash memory module 4.

According to the instruction from the controller 7, the flash memory module 4 moves from the normal mode to the evacuation mode. Specifically, the memory control circuit 40 instructs the voltage generating circuit 41 to generate a writing voltage for writing data. Further, the memory control circuit 40 stops the current operation to perform the data writing of the save data.

The voltage generating circuit 41 generates a writing voltage (high voltage) by a pumping operation according to the instruction from the memory control circuit 40. The above circuit also generates a negative high voltage as well as a positive high voltage.

The decoder group 42 is activated to charge the writing voltage lines (W, SL, and WELL) to a desired voltage level.

At the time T2, when the writing voltage line becomes the desired voltage, the select transistor is set at non-conductivity (OFF).

At the time T3, based on the charged writing voltage line, the data writing into the memory cell is performed. In this example, the control data (save data) stored in the RAM 8 is stored in the memory cell. In the case of the FN tunnel writing method for the memory cell, the data writing with lower power consumption is possible.

At the time 14, the flash memory module 4 detects the external power VDD reduced to a predetermined threshold and less and performs the reset processing.

### (b2. Description of Flow)

A flow of the evacuation mode in the flash memory module 4 will be described.

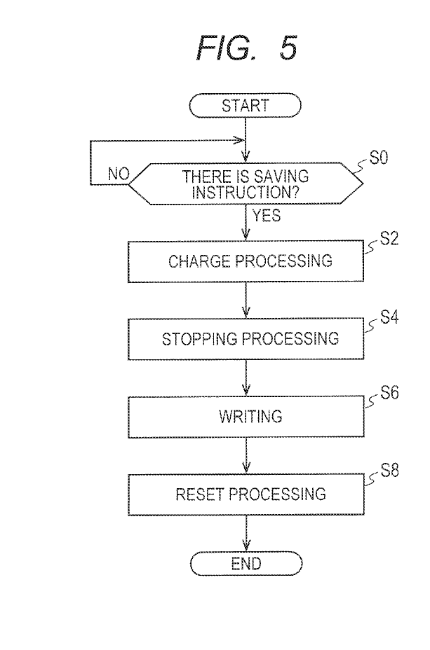

FIG. 5 is a view for use in describing the flow of the evacuation mode of the flash memory module 4 based on the embodiment.

With reference to FIG. 5, the memory control circuit 40 determines whether or not there is a saving instruction from the controller 7 (Step S0). When there is a saving instruction from the controller 7, the memory control circuit 40 moves to the evacuation mode. When there is no saving instruction, it operates in the normal mode.

Next, when determining there is the saving instruction from the controller 7 (YES in Step S0), the memory control circuit 40 moves from the normal mode to the evacuation mode and performs the charge processing (Step S2).

Specifically, the memory control circuit 40 instructs the voltage generating circuit 41 to generate a writing voltage for writing data. According to the instruction from the memory control circuit 40, the voltage generating circuit 41 generates a writing voltage (high voltage) by the pumping operation. Further, it generates a negative high voltage and a positive high voltage. Then, the decoder group 42 is activated to charge the writing voltage line (WL, SL, and WELL) to a desired voltage level.

Next, the memory control circuit 40 performs the stopping processing (Step S4). Specifically, the memory control circuit 40 sets the select transistor at non-conductivity (OFF). According to this, the writing voltage line is in a floating state.

Next, the memory control circuit 40 performs the writing processing (Step S6).

Specifically, based on the charged writing voltage line, the data writing for the memory cell is performed. In this example, the control data (save data) stored in the RAM 8 is stored in the memory cell. The control data can be stored at a predetermined address in the flash memory module 4. Specifying a predetermined address makes easy the data reading at the recovering operation time.

Alternatively, code information (Emergency Key Code (EKC)) indicating that the data saving is executed by the evacuation mode can be written at a specified address, differently from the control data. Further, the execution or non-execution of the data saving can be determined easily by the code information.

The memory control circuit 40 performs the reset processing (Step S8).

Then, the above circuit is recovered from the evacuation mode to the normal mode and finishes the processing (end).

According to the processing in the evacuation mode, it is possible to store the control data (save data) that is stored in the RAM 8, into the flash memory module 4 at the power shutdown.

### Second Embodiment

The above first embodiment has been described in the case of detecting the power shutdown of the external power VDD and saving the control data (save data) at the above shutdown time.

It is not restricted to the external power VDD but the internal power is available.

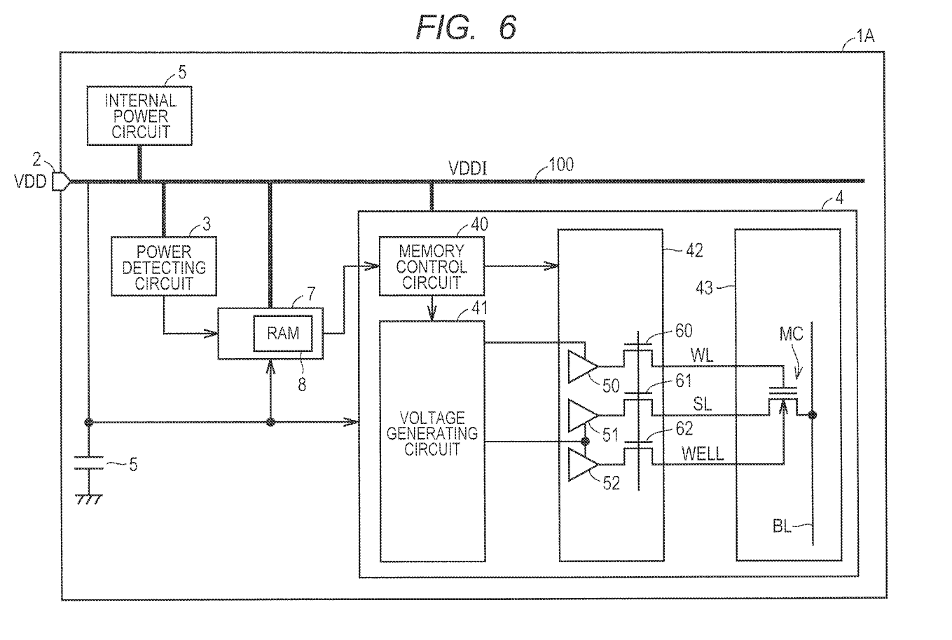

FIG. 6 is a block diagram showing the structure of a micro-computer 1A according to a second embodiment.

With reference to FIG. 6, the micro-computer 1A based on the second embodiment includes an internal power circuit 16 for generating an internal power VDDI upon receipt of the external power VDD and an internal power bus 17 for supplying an internal power voltage, instead of the power bus 9, differently from the first embodiment.

The other structure is the same as that of the first embodiment and therefore, the detailed description thereof is omitted.

Each unit operates upon receipt of the internal power VDDI. The power detecting circuit 3 monitors the state of the power supply of the internal power VDDI.

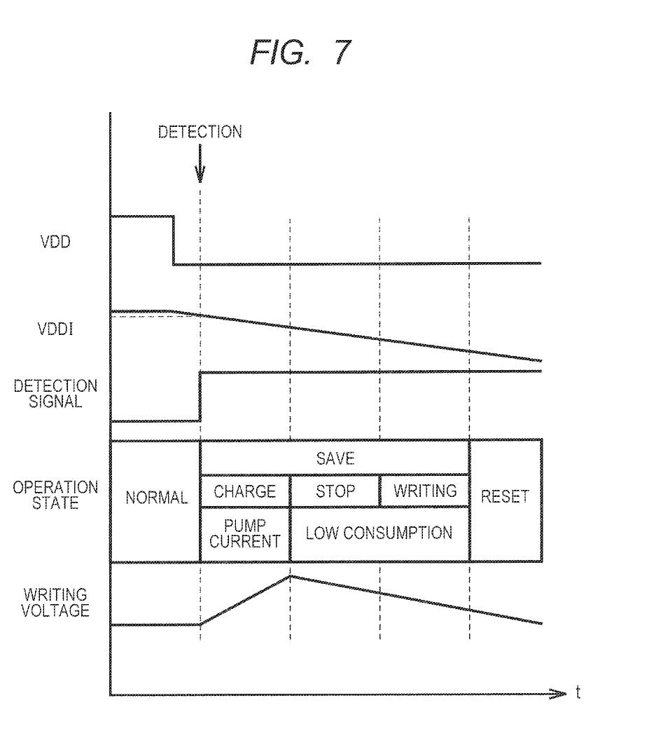

FIG. 7 is a view for use in describing timing at the power shutdown of the internal power based on the second embodiment.

As shown in FIG. 7, at the time T5, the operation when the external power VDD is shut down is shown.

At the time T6, when the internal power VDDI is reduced to a certain detection level, the power detecting circuit 3 outputs a detection signal (“H” level).

The power detecting circuit 3 outputs the detection signal to the controller 7.

Upon receipt of the detection signal (“H” level) from the power detecting circuit 3, the controller 7 instructs the flash memory module 4 to move from the normal (Normal) mode to the evacuation mode. Further, the controller 7 reads the save data stored in the RAM 8 and outputs the save data to the flash memory module 4.

The flash memory module 4 moves from the normal mode to the evacuation mode, according to the instruction from the controller 7. Specifically, the memory control circuit 40 instructs the voltage generating circuit 41 to generate a writing voltage for the data writing. The memory control circuit 40 stops the current operation to perform the data writing of the save data.

The voltage generating circuit 41 generates a writing voltage (high voltage) by the pumping operation, according to the instruction from the memory control circuit 40. Here, it also generates a negative high voltage as well as a positive high voltage.

The decoder group 42 is activated to charge the writing voltage line (WL, SL, and WELL) to a desired voltage level.

At the time T7, when the writing voltage line becomes a desired voltage, the select transistor is set at non-conductivity (OFF).

At the time T8, based on the charged writing voltage line, the data writing for the memory cell is performed. In this example, the control data (save data) stored in the RAM 8 is stored in the memory cell. In the case of the FN tunnel writing method for the memory cell, data can be written with lower power consumption.

At the time 9, after detecting the external power VDD reduced to a predetermined threshold and less and performing the reset processing, the flash memory module 4 is recovered from the evacuation mode to the normal mode.

According to the processing in the evacuation mode, it is possible to store the control data (save data) that is stored in the RAM 8, into the flash memory module 4 even at the power shutdown of the internal power.

### Third Embodiment

The above embodiments have been described in the case of generating a writing voltage (high voltage) according to the pumping operation in the flash memory module 4. On the other hand, the writing voltage may be input from the outside of the flash memory module 4.

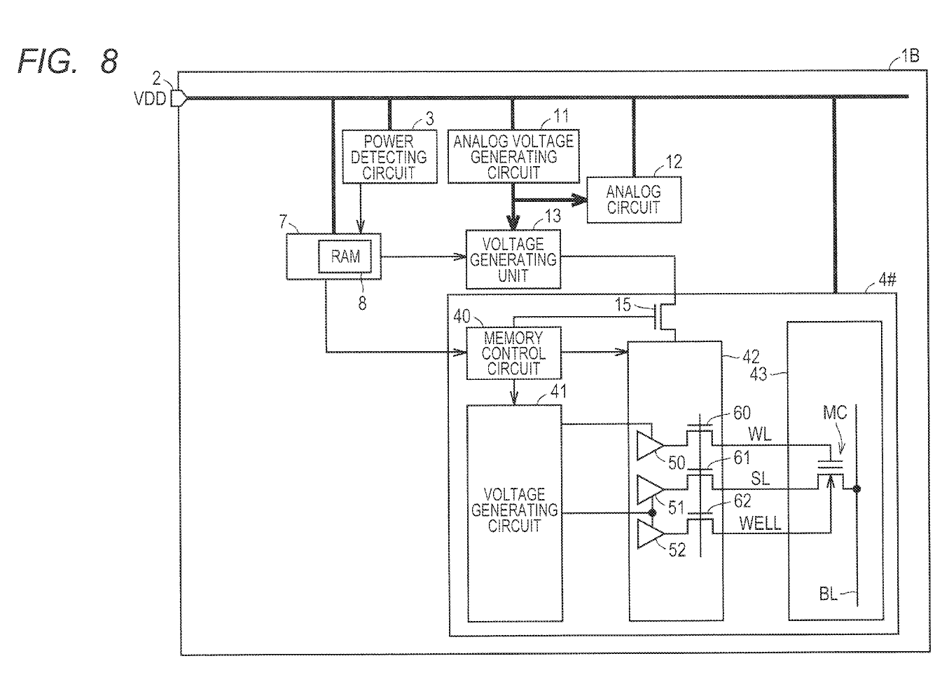

FIG. 8 is a block diagram showing a structure of a micro-computer 1B based on a third embodiment.

With reference to FIG. 8, the micro-computer 1B based on the third embodiment is different from the micro-computer 1 based on the first embodiment in that it includes an analog circuit 12, an analog voltage generating circuit 11 which supplies a voltage to the analog circuit 12, and a voltage generating unit 13 which adjusts the voltage level of the voltage generated by the analog voltage generating circuit 11 and that a flash memory module 4# is substituted for the flash memory module 4. In this example, the condenser 5 is not provided.

The flash memory module 4# is different from the flash memory module 4 in that a path for supplying a voltage from the voltage generating unit 13 to the decoder group 42 is provided and that a transistor 15 is provided in the above voltage supplying path.

The transistor 15 operates according to the instruction from the memory control circuit 40. In this example, the transistor 15 is set to be conductive in the evacuation mode and not to be conductive in the normal (Normal) mode.

In this example, for the sake of brief description, only one voltage supplying path from the voltage generating unit 13 to the decoder group 42 is described; however, a plurality of writing voltage supplying paths may be naturally possible. In this case, a plurality of the transistors 15 can be provided.

The other structure is the same as that of FIG. 1, and therefore, the detailed description thereof is omitted.

Generally, a voltage used in the analog circuit 12 is higher than that used in the flash memory module 4# in many cases. Therefore, in the third embodiment, the voltage for the analog circuit 12 is used to generate a writing voltage used for the flash memory module 4#.

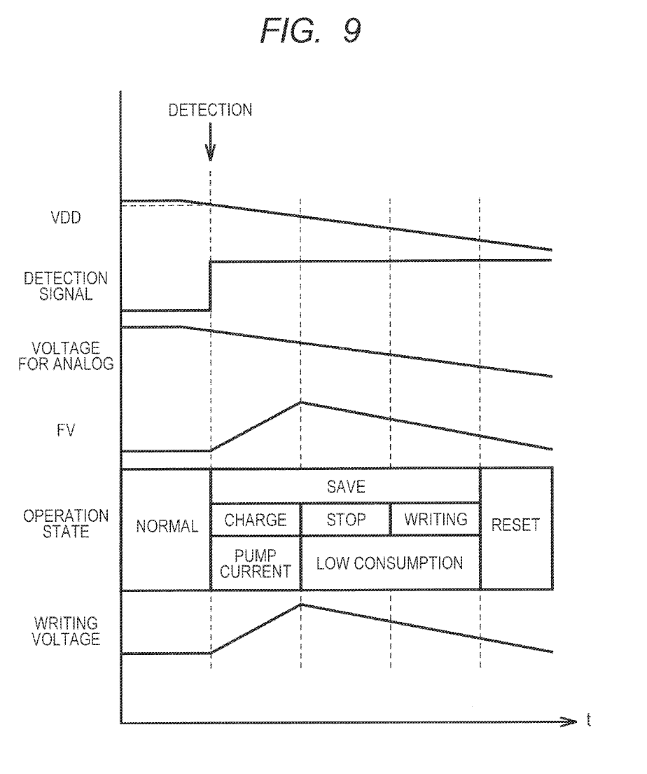

FIG. 9 is a view for use in describing timing at the power shutdown of the external power based on the third embodiment.

As shown in FIG. 9, at the time T10, when the external power VDD is reduced to a certain detection level, the power detecting circuit 3 outputs a detection signal (“H” level).

The power detecting circuit 3 outputs the detection signal to the controller 7.

Upon receipt of the detection signal (“H” level) from the power detecting circuit 3, the controller 7 instructs the voltage generating unit 13 to be activated.

Activated according to the instruction from the controller 7, the voltage generating unit 13 reduces the voltage generated in the analog voltage generating circuit 11 to generate a writing voltage (high voltage). Here, it also generates a negative high voltage as well as a positive high voltage.

The writing voltage generated in the voltage generating unit 13 is supplied to the flash memory module 4#.

The controller 7 instructs the flash memory module 4# to mover from the normal (Normal) mode to the evacuation mode. The controller 7 reads the save data stored in the RAM 8 and outputs the save data to the flash memory module 4#. According to the instruction form the controller 7, the flash memory module 4# moves from the normal mode to the evacuation mode. The memory control circuit 40 stops the current operation to perform the data writing of the save data. Specifically, the memory control circuit 40 controls the transistor 15 to be conductive to supply the writing voltage generated in the voltage generating unit 13 to the decoder group 42.

The memory control circuit 40 activates the decoder group 42 to charge the writing voltage line (WL, SL, and WELL) to a desired voltage level.

At the time 11, when the writing voltage line becomes the desired voltage, the select transistor is set at non-conductive (OFF).

At the time 12, based on the charged writing voltage line, the data writing for the memory cell is performed. In this example, the control data (save data) stored in the RAM 8 is stored in the memory cell. In the case of the FN tunnel writing method for the memory cell, the data writing with lower power consumption is possible.

At the time 13, after detecting the external power VDD reduced to a predetermine threshold and less and performing the reset processing, the flash memory module 4# is recovered from the evacuation mode to the normal mode.

According to the processing in the evacuation mode, even at the power shutdown of the external power, it is possible to store the control data (save data) that is stored in the RAM 8, into the flash memory module 4#.

Further, it is possible to generate a writing voltage by using the voltage for the analog circuit 12, without generating a writing voltage (high voltage) according to the pumping operation, in the flash memory module 4#. According to this, the control data (save data) can be stored at high speed without any need to secure a time for the pumping operation.

### Fourth Embodiment

In a fourth embodiment, a method of performing the recovery processing with the control data (save data) will be described.

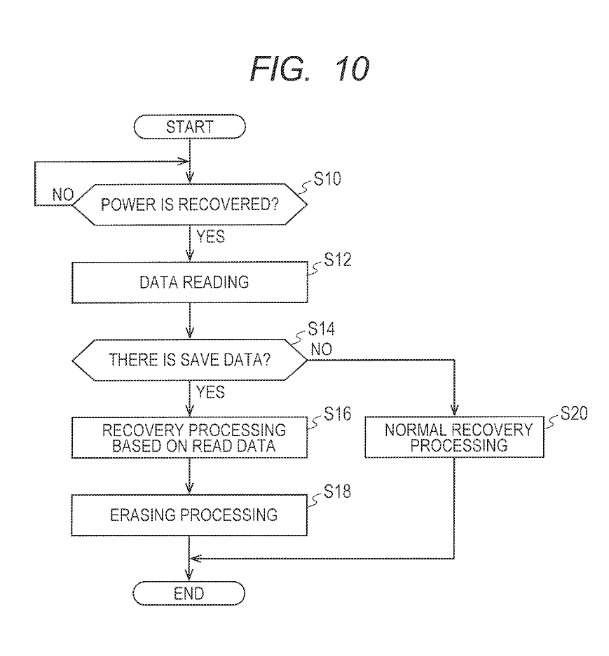

FIG. 10 is a flow for use in describing the recovery processing of a semiconductor device based on the fourth embodiment.

With reference to FIG. 10, the controller 7 determines whether or not the power is recovered (Step S10), according to the detection signal (“L” level) from the power detecting circuit 3.

In Step S10, when the controller 7 determines that the power is recovered (YES in Step S10), the data reading is performed (Step S12). The controller 7 instructs the flash memory module 4 to read the data stored in the memory cell. Here, the date at a predetermined address may be read.

The controller 7 checks whether or not there is the save data (Step S14). The controller 7 checks whether or not the read data includes the save data. Specifically, whether or not the read data includes the code information indicating the execution of the data saving may be checked. When the code information agrees with the data previously held, it may be determined that the save data is included.

In Step S14, when the controller 7 determines that there is the save data (YES in Step S14), it performs the recovery processing based on the save data read through the data reading (Step S16). The controller 7 performs the recovery processing for setting the parameters of the respective units in the semiconductor device into a state before the recovery, based on the save data.

The controller 7 performs the erasing processing of the save data (Step S18). Specifically, after performing the reset processing of the data stored in the RAM 8, the evacuation mode is recovered to the normal mode.

Then, the processing is finished (end).

On the other hand, in Step S14, when the controller 7 determines that there is no save data (NO in Step S14), the normal recovery processing is performed (Step S20). The controller 7 performs the recovery processing for setting the parameters of the respective units in the semiconductor device to the initial values.

Then, the processing is finished (end).

In this example, although the case of determining the recovery of the power according to the detection signal from the power detecting circuit 3 has been described, it is not restricted to the above structure, but the recover of the power may be determined by using a power-on reset signal.

As set forth hereinabove, the disclosure has been specifically described base on the embodiments; it is needless to say that the invention is not restricted to the embodiments but various modifications is possible without departing from its spirit.

What is claimed is:

1. A semiconductor device of receiving a power, comprising:
a memory unit including a plurality of memory cells capable of storing data;
a power detecting circuit that detects shutdown of the power; and
a condenser capable of temporarily supplying an operation voltage, instead of the power, at the power shutdown,
wherein the memory unit includes
a voltage generating unit that generates a plurality of writing voltages based on the operation voltage from the condenser at the power shutdown, and
a writing circuit that performs data writing of save data for the memory cells, based on the writing voltages generated by the voltage generating unit.

2. The device according to claim 1,
wherein the writing circuit includes
a plurality of drivers that operate upon receipt of the writing voltages generated by the voltage generating unit,
a plurality of writing voltage lines provided correspondingly to the drivers, and
a plurality of transistors respectively provided between the drivers and the writing voltage lines, and
wherein the transistors are set at non-conductive state after the drivers charge the writing voltage lines.

3. The device according to claim 1, further comprising:
an internal power circuit that supplies a power to an internal circuit upon receipt of the power from an outside,
wherein the power detecting circuit detects shutdown of the power from the internal power circuit.

4. The device according to claim 1,
wherein the save data includes a save code, and
the above device further comprising a recovery processing unit that determines whether or not the save code is stored in the memory unit at a recovery of the power and performs a recovery operation based on the save data when the save code is stored.

5. The device according to claim 4,
wherein the recovery processing unit performs a normal recovery operation when the save data is not stored.

6. The device according to claim 4,
wherein the recovery processing unit receives a power recovery signal from the power detecting circuit.

7. A semiconductor device of receiving a power, comprising:
an analog circuit;
an analog voltage generating circuit that generates a voltage to be supplied to the analog circuit;
a memory unit including a plurality of memory cells capable of storing data;
a power detecting circuit that detects shutdown of the power; and
a voltage generating unit that generates a writing voltage based on the voltage generated by the analog voltage generating circuit at the power shutdown,
wherein the memory unit includes a writing circuit that performs data writing of save data for the memory cells based on the writing voltage generated by the voltage generating unit.

8. The device according to claim 7,
wherein the writing circuit includes
a plurality of drivers that operate upon receipt of the writing voltages generated by the voltage generating unit,
a plurality of writing voltage lines respectively provided correspondingly to the drivers, and
a plurality of transistors respectively provided between the drivers and the writing voltage lines,
wherein the transistors are set at a non-conductive state after the drivers charge the writing voltage lines.

9. The device according to claim 7, further comprising
an internal power circuit that supplies a power to an internal circuit upon receipt of the power from an outside,
wherein the power detecting circuit detects shutdown of the power from the internal power circuit.

10. The device according to claim 7,
wherein the save data includes a save code, and
the above device further comprising a recovery processing unit that determines whether or not the save code is stored in the memory unit at a recovery of the power and performs a recovery operation based on the save data when the save code is stored.

11. The device according to claim 10,
wherein the recovery processing unit performs a normal recovery operation when the save data is not stored.

12. The device according to claim 10,
wherein the recovery processing unit receives a power recovery signal from the power detecting circuit.
